(19) United States
(12) Patent Application Publication
(10) Pub. No.: US 2014/0255149 A1
(43) Pub. Date: Sep. 11, 2014

(54) DUAL INLET TURBINE PUMP

(71) Applicant: AIRTEX PRODUCTS, LP, Fairfield, IL (US)

(72) Inventors: Robert Barnett, Fairfield, IL (US); Bruce Stephens, Fairfield, IL (US)

(73) Assignee: AIRTEX PRODUCTS, LP, Fairfield, IL (US)

(21) Appl. No.: 14/195,306

(22) Filed: Mar. 3, 2014

Related U.S. Application Data
(60) Provisional application No. 61/774,455, filed on Mar. 7, 2013.

(51) Int. Cl. F02M 37/00; F03D 3/00

(52) U.S. Cl. CPC F02M 37/0088; F03D 3/00
USPC 415/1; 415/116

(57) ABSTRACT

A pump for providing a flow of fluid from a fluid source to a fluid destination. The pump includes a rotatable turbine, a first inlet port in fluid communication with the turbine, a first outlet port in fluid communication with the first inlet port, a second inlet port in fluid communication with the turbine, and a second outlet port in fluid communication with the second inlet port. The turbine pumps fluid from the fluid source into the first inlet port and out of the first inlet port into a reservoir. The turbine pumps fluid in the reservoir into the second inlet port and out of the second outlet port to the fluid destination.

### CROSS REFERENCE TO RELATED APPLICATIONS

This application claims priority under 35 U.S.C. §119(e) to U.S. Provisional Application Ser. No. 61/774,455, filed Mar. 7, 2013, which is expressly incorporated by reference herein.

### BACKGROUND

The present disclosure is directed to pumps for providing a flow of fluid from a fluid source to a fluid destination, and in particular to pumps including a rotatable turbine that provides a fluid flow path through the pump.

### SUMMARY

A pump for pumping fluid from a fluid source to a fluid destination. The pump includes a first inlet port adapted to be in fluid communication with the fluid source. A turbine having a central axis and that is adapted to rotate about the central axis, is in fluid communication with the first inlet port. A first outlet port is in fluid communication with the turbine and the first inlet port. A first fluid flow path extends between the first inlet port and the first outlet port. The turbine is adapted to cause fluid to flow through the first fluid flow path from the first inlet port to the first outlet port. A second inlet port is adapted to be in fluid communication with fluid discharged from the first outlet port. The turbine is in fluid communication with the second inlet port. A second outlet port is in fluid communication with the turbine and the second inlet port. A second fluid flow path extends between the second inlet port and the second outlet port. The second outlet port is adapted to be placed in fluid communication with the fluid destination. The turbine is adapted to cause fluid to flow through the second fluid flow path from the second inlet port to the second outlet port.

### BRIEF DESCRIPTION OF THE DRAWING FIGURES

FIG. 1 is a diagrammatic view of the dual inlet turbine pump of the present disclosure shown located within a fuel reservoir and with the fuel reservoir located within a fuel tank for the pumping of fuel from the fuel tank to an engine;

FIG. 2 is a partially exploded perspective view of the dual inlet turbine pump;

FIG. 3 is a partially exploded cross sectional perspective view of the pump showing the first fluid flow path through the turbine of the pump;

FIG. 4 is a partially exploded cross sectional perspective view of the pump showing the second fluid flow path through the turbine of the pump;

FIG. 5 is a cross sectional view of the pump;

FIG. 6A is a front perspective view of the end cap of the pump;

FIG. 6B is a rear perspective view of the end cap of the pump;

FIG. 6C is a front elevational view of the end cap of the pump;

FIG. 6D is a rear elevational view of the end cap of the pump;

FIG. 6E is a left side elevational view of the end cap of the pump;

FIG. 6F is a right side elevational view of the end cap of the pump;

FIG. 6G is a cross sectional view of the end cap of the pump taken along line 6G-6G of FIG. 6C;

FIG. 6H is a cross sectional view of the end cap of the pump taken along line 6H-6H of FIG. 6C;

FIG. 7A is a front perspective view of the turbine of the pump;

FIG. 7B is a rear perspective view of the turbine of the pump;

FIG. 7C is a front elevational view of the turbine of the pump;

FIG. 7D is a side elevational view of the turbine of the pump;

FIG. 7E is a rear elevational view of the turbine of the pump;

FIG. 7F is a cross sectional view of the turbine taken along line 7F-7F of FIG. 7C;

FIG. 8A is a front perspective view of the collar of the pump;

FIG. 8B is a rear perspective view of the collar of the pump;

FIG. 8C is a front elevational view of the collar of the pump;

FIG. 8D is a side elevational view of the collar of the pump;

FIG. 8E is a rear elevational view of the collar of the pump;

FIG. 8F is a cross sectional view of the collar of the pump taken along line 8F-8F of FIG. 8C; and

FIG. 8G is a cross sectional view of the collar of the pump taken along line 8G-8G of FIG. 8C.

### DETAILED DESCRIPTION

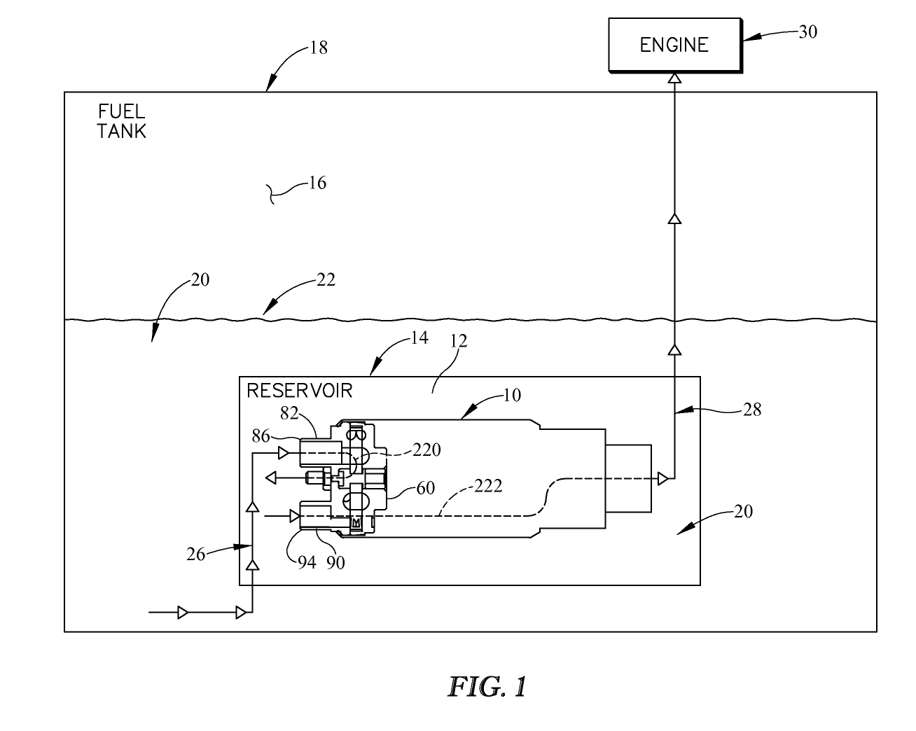

The present disclosure relates to a pump for pumping a fluid from a fluid source to a fluid destination. An embodiment of the pump is shown in the accompanying drawing figures as pump 10. As illustrated in FIG. 1 pump 10 may be located within a chamber 12 of a reservoir 14. Reservoir 14 may be located in a chamber 16 of a tank 18, such as a fuel tank. A fluid such as liquid fuel 20 is located within chamber 16 of fuel tank 18 and chamber 12 of reservoir 14. Liquid fuel 20 within chamber 16 of fuel tank 18 is shown having a liquid surface 22. Liquid fuel 20 may comprise gasoline, diesel fuel, or other types of liquid fuel. Pump 10 pumps fuel 20 through a first fluid flow path 26 from chamber 16 of fuel tank 18 to chamber 12 of reservoir 14. Pump 10 also simultaneously pumps fuel 20 from chamber 12 of reservoir 14 through a second fluid flow path 28 to an engine 30 located externally of fuel tank 18. Pump 10, reservoir 14, fuel tank 18 and engine 30 may comprise components of a vehicle or other type of machinery or equipment.

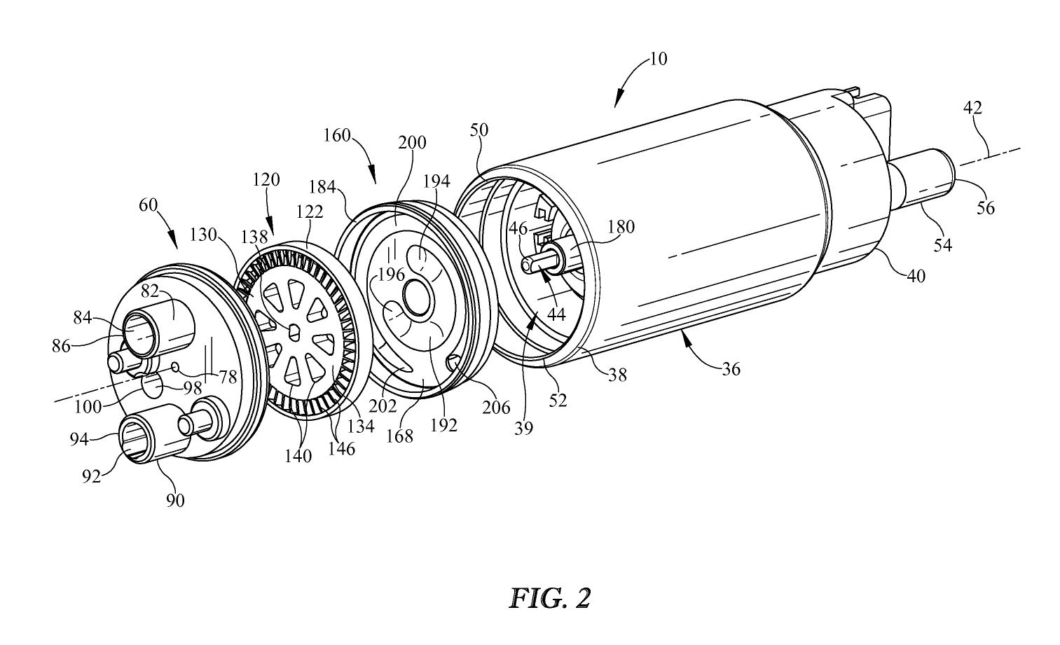

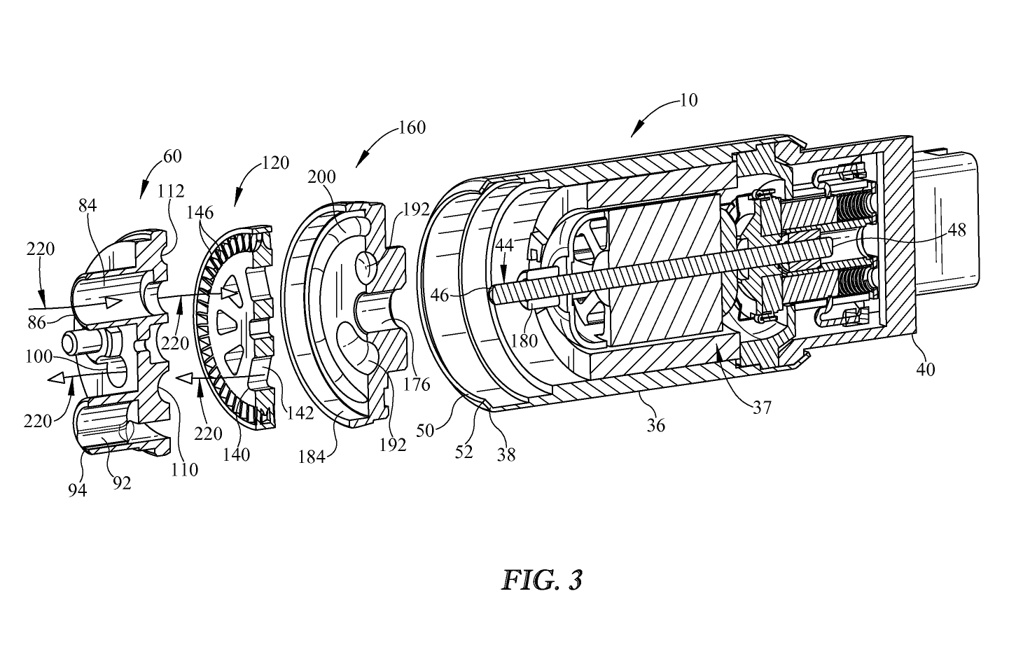

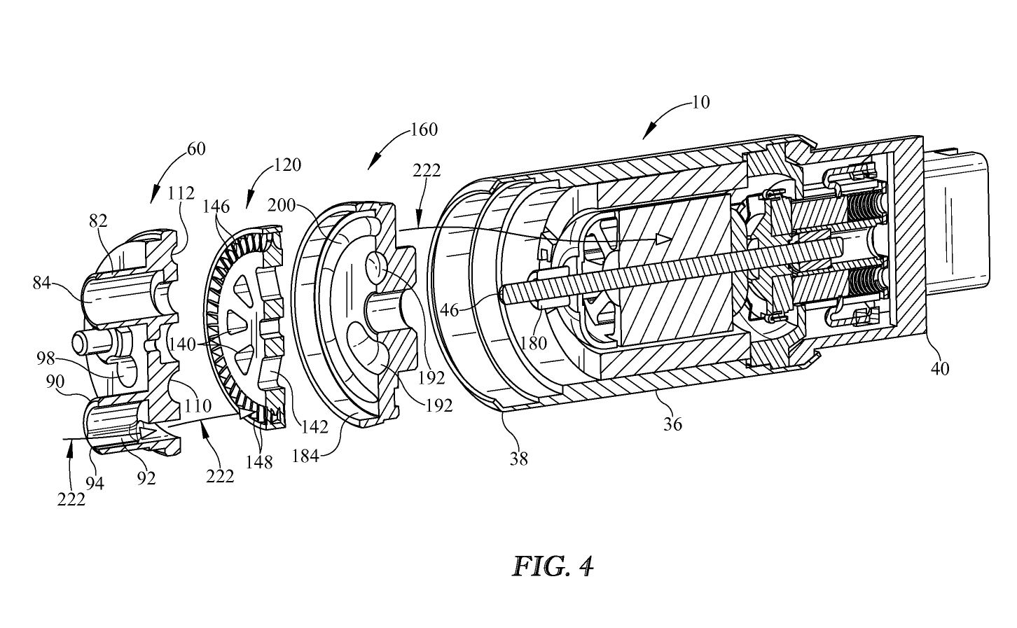

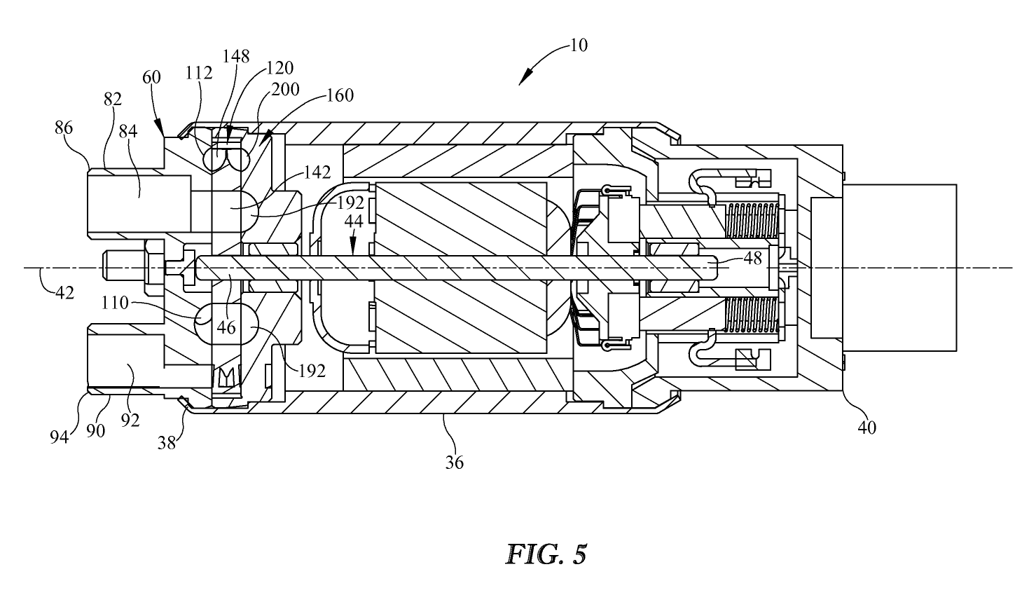

Pump 10 includes a generally cylindrical housing 36 that extends from a first end 38 to a second end 40, as shown in FIG. 2. Housing 36 includes a central longitudinal axis 42. An elongate shaft 44 having a first end 46 and a second end 48 is located within housing 36 and extends concentrically along axis 42. Shaft 44 is selectively rotatable about axis 42 with respect to housing 36 by an electric motor 37 located within housing 36. First end 38 of housing 36 includes an opening 50 formed by a generally circular peripheral rim 52. An annular nipple 54 having an outlet port 56 is located at second end 40 of housing 36. Outlet port 56 is in fluid communication with a fluid chamber 39 located within housing 36.

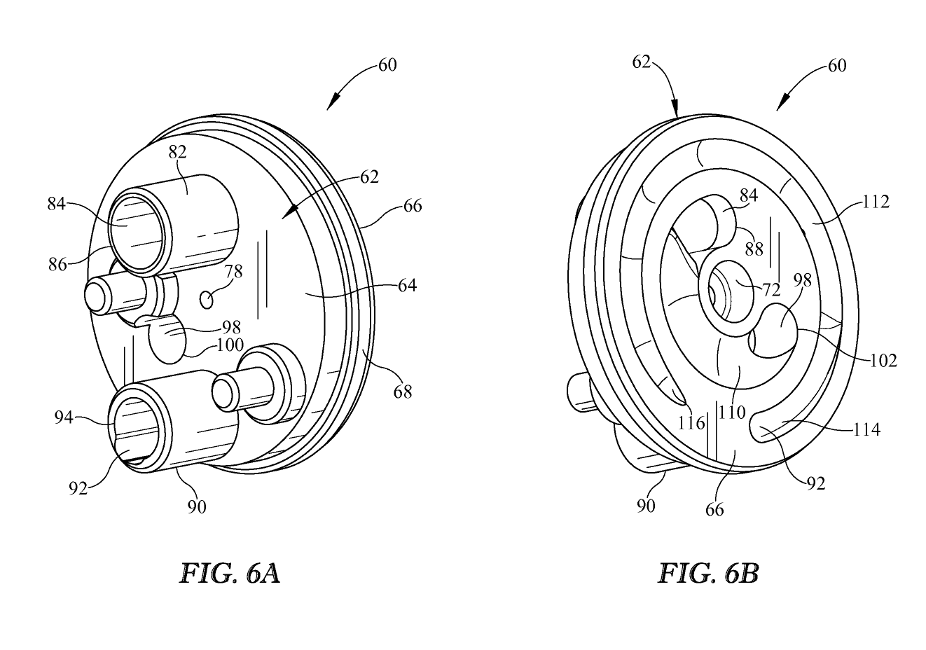

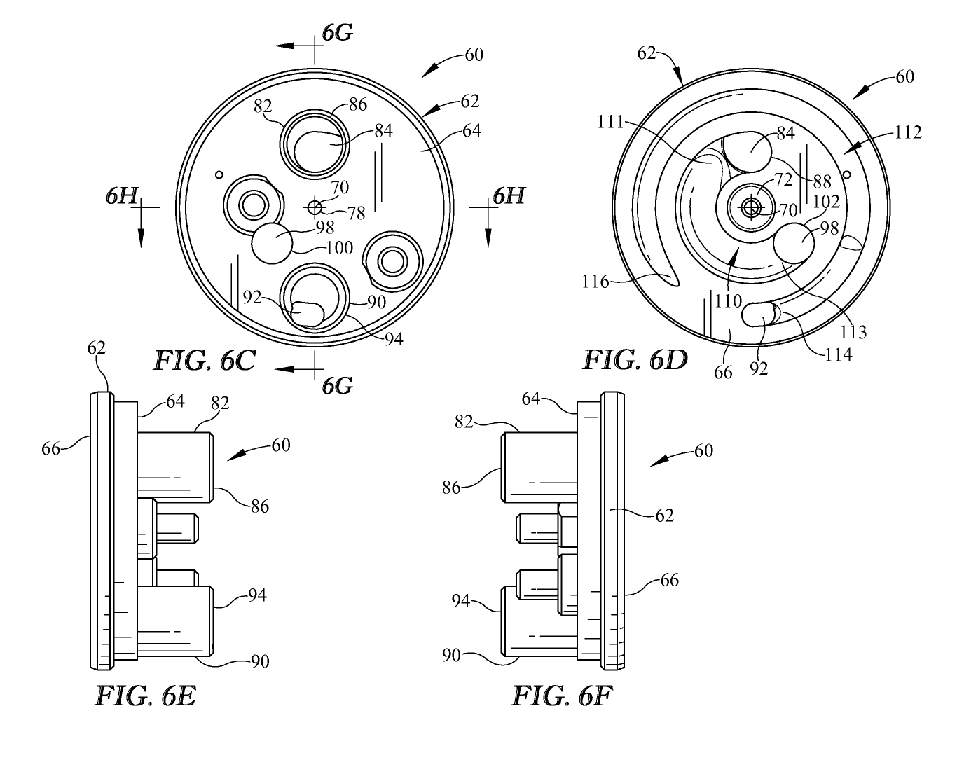

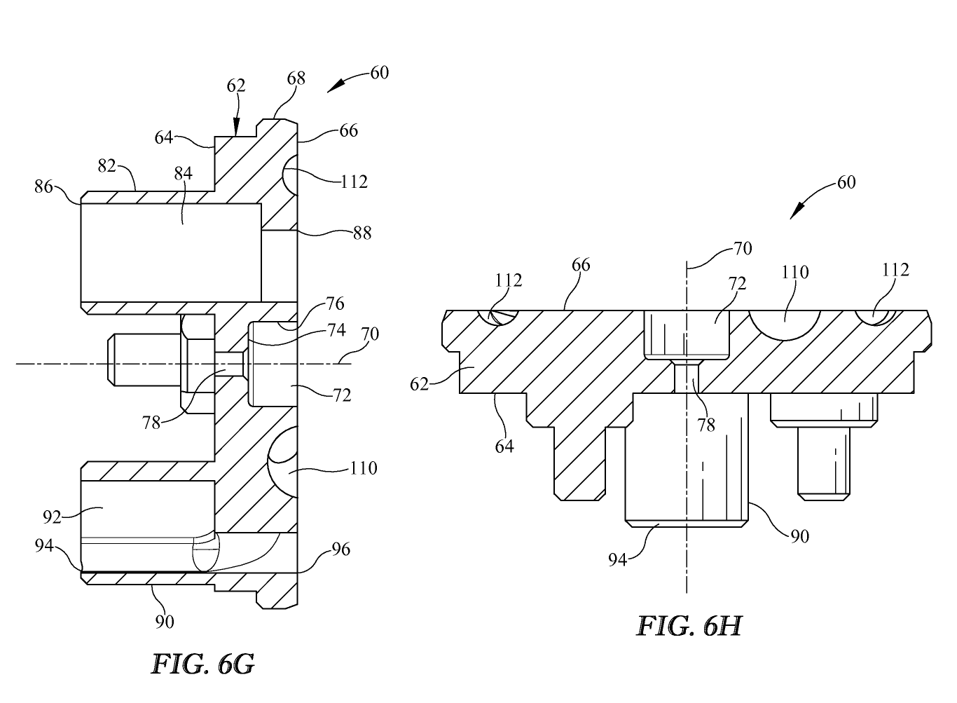

Pump 10 includes an end cap 60 coupled to first end 38 of housing 36. As shown in FIGS. 6A-6H end cap 60 includes a base 62 having a generally planar exterior surface 64 and a spaced apart and generally parallel planar interior surface 66. Base 62 includes a generally circular peripheral edge 68 that extends between exterior surface 64 and interior surface 66. Edge 68 extends generally concentrically about a central axis 70 of end cap 60. Axis 70 is generally coaxial with axis 42. Base 62 includes a chamber 72 that extends inwardly from interior surface 66 to a generally annular end wall 74. Chamber 72 also includes a generally cylindrical side wall 76 that extends generally concentrically about axis 70. Base 62 also includes a generally cylindrical bore 78 that extends from exterior surface 64 to end wall 74 along axis 70. Bore 78 is in communication with chamber 72.

End cap 60 includes a first nipple 82 extending outwardly from exterior surface 64 of base 62 generally parallel to axis 70, as shown in FIG. 6A. A bore 84 extends through first nipple 82 and base 62 from an inlet port 86 located at a distal end of first nipple 82 to a port 88 located in interior surface 66 of base 62. End cap 60 also includes a second nipple 90 extending outwardly from exterior surface 64 of base 62 generally parallel to axis 70. Second nipple 90 includes a bore 92 that extends through end cap 60 from an inlet port 94 located at a distal end of second nipple 90 to a port 96 located at interior surface 66 of base 62. Second nipple 90 is located radially outwardly from axis 70 a distance that is farther than the distance at which first nipple 82 is located from axis 70. End cap 60 also includes a bore 98 that extends through end cap 60 from an outlet port 100 located at exterior surface 64 of base 62 to a port 102 located at interior surface 66 of base 62.

End cap 60 includes a curved inner groove 110 formed in interior surface 66 of base 62, as shown in FIG. 6B. Inner groove 110 is curved in a generally circular manner about axis 70 and extends from a first end 111 located at and in fluid communication with bore 84 of first nipple 82 to a second end 113 located at and in fluid communication with bore 98 of end cap 60 approximately 230 degrees about axis 70 from a centerline of bore 84 to a centerline of bore 98. Inner groove 110 provides a fluid flow channel between inlet port 86 of first nipple 82 and outlet port 100 of bore 98 in end cap 60.

End cap 60 also includes a curved outer groove 112 formed in interior surface 66 of base 62, as shown in FIG. 6B. Outer groove 112 is curved in a generally circular manner about axis 70 and is located radially outwardly from inner groove 110. Outer groove 112 extends from a first end 114 located at and in fluid communication with bore 92 of second nipple 90 to a second end 116. Outer groove 112 extends approximately 273 degrees about axis 70. Outer groove 112 provides a fluid flow channel between inlet port 94 of second nipple 90 and second end 116 of outer groove 112. Inner groove 110 and outer groove 112 are generally curved in cross section in a generally circular manner.

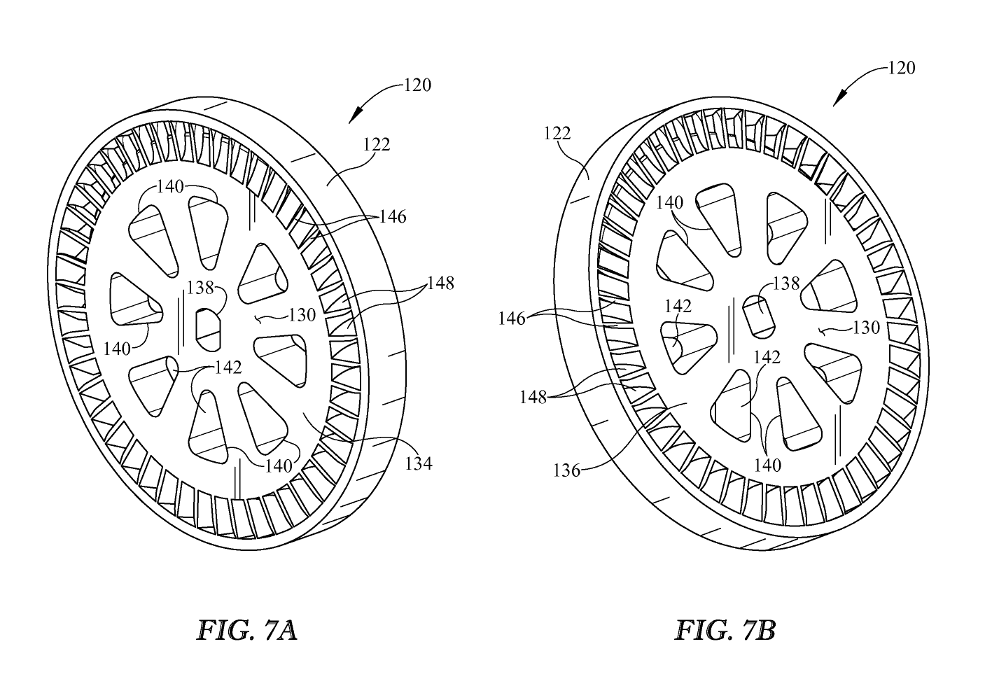

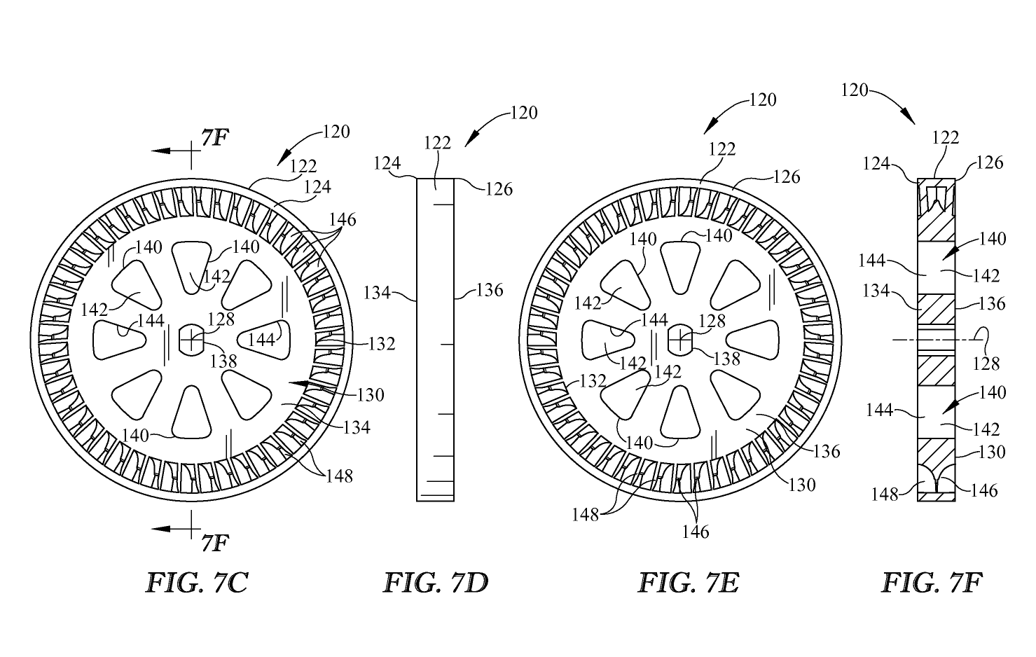

Pump 10 includes an impeller or turbine 120 as shown in FIGS. 7A-7F. Turbine 120 includes a generally cylindrical side wall 122 that extends from a generally circular outer edge 124 to a generally circular inner edge 126. Turbine 120 includes a central axis 128 and side wall 122 extends generally concentrically about axis 128. Axis 128 is generally coaxial with axes 42 and 70. Turbine 120 includes a generally cylindrical disk 130 located generally concentrically within side wall 122 and about axis 128. Disk 130 includes a generally cylindrical side wall 132 that is generally uniformly spaced apart from and within side wall 122. Disk 130 also includes a generally planar exterior surface 134 and a spaced apart and generally parallel planar interior surface 136. Disk 130 includes a non-circular central aperture 138 that extends between exterior surface 134 and interior surface 136 concentrically about axis 128. Aperture 138 is adapted to receive first end 46 of shaft 44 such that turbine 120 is rotatably coupled to shaft 44 for conjoint rotation with shaft 44 about axes 42, 70 and 128 with respect to housing 36 and end cap 60 of pump 10. Axis 128 of turbine 120 is generally coaxial with axis 70 of end cap 60 and axis 42 of housing 36.

Disk 130 includes a plurality of inner blades 140 that are generally equally spaced apart from one another and that are located in a generally circular manner about axis 128, as shown in FIGS. 7A-7B. Each inner blade 140 comprises a bore 142 that extends through disk 130 from exterior surface 134 to interior surface 136. Each bore 142 is generally in the shape of an isosceles triangle wherein the vertex of the two generally equal length sides of the triangle is located most closely adjacent to axis 128 and such that the equal length sides of the triangle diverge from one another as they extend radially outwardly away from axis 128. The base of the triangle that extends between the generally equal-length sides of the triangle is located most closely adjacent to side wall 132 of disk 130. Each inner blade 140 includes a generally triangular-shaped side wall 144 that extends between exterior surface 134 and interior surface 136 of disk 130 generally perpendicular thereto.

Turbine 120 also includes a plurality of outer blades 146 that extend between side wall 132 of disk 130 and side wall 122 of turbine 120. Outer blades 146 are generally equally spaced apart from one another and are located in a generally circular manner about axis 128. Outer blades 146 extend generally radially outwardly from axis 128 between side wall 132 of disk 130 and side wall 122 of turbine 120 and are located at a non-perpendicular angle to exterior surface 134 and interior surface 136 of disk 130. A fluid passage 148 extends through turbine 120 between each pair of adjacent outer blades 146. Turbine 120 is located within first end 38 of housing 36 with exterior surface 134 located closely adjacent interior surface 66 of end cap 60. Outer blades 146 produce a higher fuel pressure than inner blades 140.

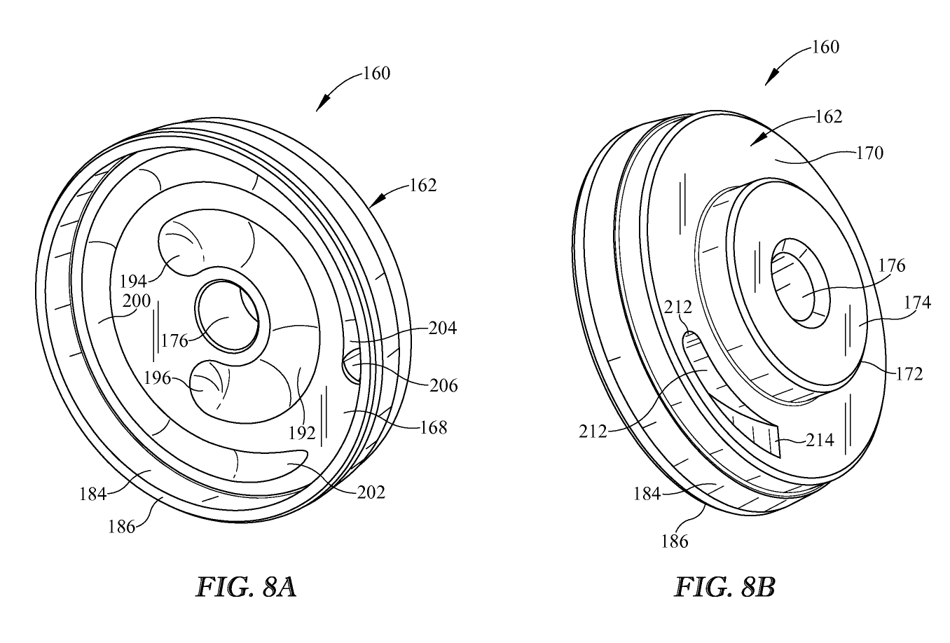

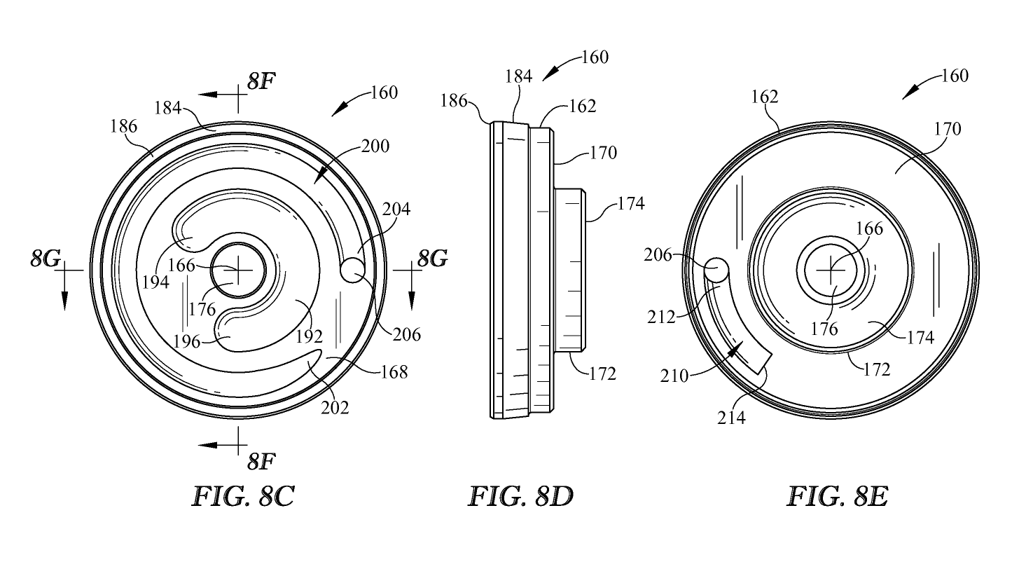

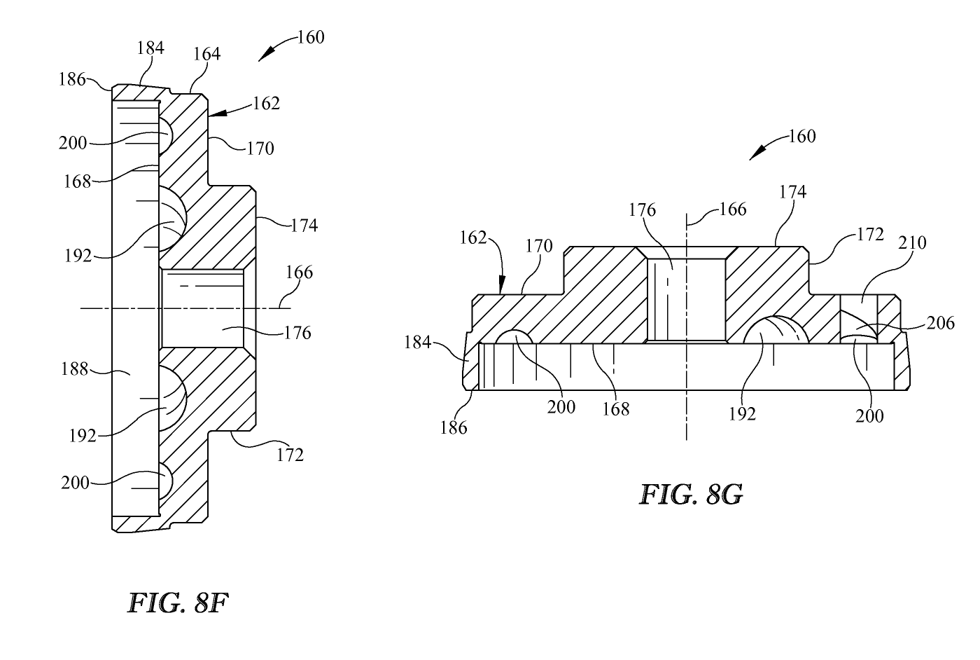

Pump 10 also includes a collar 160 as shown in FIGS. 8A-G. Collar 160 includes a generally cylindrical and plate-like base 162. Base 162 includes a generally cylindrical edge surface 164 that extends generally concentrically about a central axis 166 of collar 160. Axis 166 is generally coaxial with axes 42, 70 and 128. Base 162 also includes a generally planar exterior surface 168 and a spaced apart and generally parallel planar interior surface 170 that are both generally perpendicular to axis 166. Collar 160 includes a generally cylindrical hub 172 that extends outwardly from interior surface 170 of base 162 generally concentrically about and along axis 166. Hub 172 includes a generally planar circular end wall 174. A bore 176 extends through base 162 and hub 172 from exterior surface 168 to end wall 174 along and generally concentrically about axis 166. First end 46 of shaft 44 is adapted to extend through bore 176. A bushing 180 is located within bore 176 and between shaft 44 and collar 160 such that shaft 44 is rotatable about axis 42 and axis 166 with respect to collar 160. Collar 160 includes a generally cylindrical side wall 184 that extends outwardly from exterior surface 168 of base 162 generally concentrically about axis 166 to a generally circular rim 186. Side wall 184 extends about axis 166 generally along and adjacent to edge surface 164 of base 162. Collar 160 includes a chamber 188 formed within side wall 184.

Base 162 of collar 160 includes a curved inner groove 192 formed in exterior surface 168 of base 162 that extends from a first end 194 to a second end 196. Inner groove 192 is curved in a generally circular manner and extends generally concentrically about axis 166 and bore 176 approximately 273 degrees. Curved inner groove 192 of collar 160, curved inner groove 110 of end cap 60 and bores 142 of inner blades 140 of turbine 120 are located at approximately the same radial distance from axis 42.

Collar 160 also includes a curved outer groove 200 formed in exterior surface 168 of base 162 that extends in a generally circular manner concentrically about axis 166 from a first end 202 to a second end 204. Outer groove 200 is located radially outwardly from inner groove 192 with respect to axis 166 and extends partially around inner groove 192. Outer groove 200 and inner groove 192 are curved in cross section in a generally circular manner. Outer groove 200 extends approximately 322 degrees about axis 166. A bore 206 extends through base 162 of collar 160 from exterior surface 168 to interior surface 170. Bore 206 is located at second end 204 of outer groove 200 and is in fluid communication with outer groove 200. Curved outer groove 200, bore 206 and groove 210 of collar 160, curved outer groove 112 of end cap 60 and fluid passageways 148 of outer blades 146 of turbine 120 are all located at approximately the same radial distance from axis 42.

Base 162 of collar 160 also includes a curved groove 210 formed in interior surface 170 of base 162. Groove 210 is curved in a generally circular manner about axis 166 and extends from a first end 212 to a second end 214. Groove 210 extends approximately 55 degrees about axis 166. First end 212 of groove 210 is located at bore 206 and is in fluid communication with bore 206. A fluid flow channel is provided from first end 202 of outer groove 200 to second end 204 of outer groove 200, through bore 206, and from first end 212 to second end 214 of groove 210. Turbine 120 is located within chamber 188 of collar 160 such that side wall 122 of turbine 120 is located closely adjacent to side wall 184 of collar 160 and interior surface 136 of turbine 120 is located closely adjacent exterior surface 168 of base 162 of collar 160.

Each bore 142 of inner blades 140 of turbine 120 is in intermittent fluid communication with port 102 of bore 98, inner groove 110 and port 88 of bore 84 as turbine 120 rotates about axis 42 with respect to end cap 60. Each inner blade 140 rotates about axis 42 from port 88 and first end 111 of inner groove 110 along inner groove 110 to port 102 at second end 113 of inner groove 110. Each bore 142 of inner blades 140 of turbine 120 is also in intermittent fluid communication with inner groove 192 of collar 160 as turbine 120 rotates about axis 42 with respect to collar 160. Each inner blade 140 rotates about axis 42 from first end 194 to second end 196 of inner groove 192 of collar 160.

Each fluid passageway 148 formed between adjacent outer blades 146 of turbine 120 is in intermittent fluid communication with bore 92 and outer groove 112 of end cap 60 as turbine 120 rotates about axis 42 with respect to end cap 60. Each fluid passageway 148 rotates about axis 42 from bore 92 at first end 114 of outer groove 112 along outer groove 112 to second end 116 of outer groove 112. Each fluid passageway 148 of turbine 120 is in intermittent fluid communication with outer groove 200 and bore 206 of collar 160 as turbine 120 rotates about axis 42 with respect to collar 160. Each fluid passageway 148 rotates about axis 42 from first end 202 to second end 204 of outer groove 200 and to bore 206.

Rotation of turbine 120 with respect to end cap 60 and collar 160 causes fuel 20 to flow through pump 10 along a low pressure fluid flow path 220, wherein fuel 20 flows into inlet port 86 of first nipple 82 and through bore 84 into inner groove 110 of end cap 60, from inner groove 110 through bores 142 of inner blades 140 of turbine 120, and into inner groove 192 of collar 160. Fuel 20 flows from inner groove 192 of collar 160 through bores 142 of inner blades 140 of turbine 120 into bore 98 of end cap 160, and fuel 20 that flows from first end 111 of inner groove 110 of end cap 60 to second end 113 of inner groove 110 flows into bore 98, whereupon the fuel 20 flows through bore 98 and out outlet port 100. As illustrated in FIG. 1, inlet port 86 and bore 84 may be coupled in fluid communication with fuel 20 located within chamber 16 of fuel tank 18 by an annular conduit such as a hose, pipe or tube. Pump 10 thereby pumps fuel 20 through first fluid path 26, which includes low pressure flow path 220 within pump 10, from chamber 16 of fuel tank 18 into chamber 12 of reservoir 14.

Pump 10 also includes a high pressure fluid flow path 222 wherein rotation of turbine 120 with respect to end cap 60 and collar 160 causes fuel 20 to flow through inlet port 94 into bore 92 of second nipple 90 and into first end 114 of outer groove 112 of end cap 60. Fuel 20 flows along outer groove 112 towards second end 116 and flows through fluid passageways 148 formed between outer blades 146 of turbine 120 and into outer groove 200 of collar 160. Fuel 20 flows along outer groove 200 from first end 202 to second end 204 and through bore 206 into groove 210. Fuel 20 that exits bore 206 flows through a chamber in housing 36 of pump 10 and out outlet port 56 of nipple 54 at second end 40 of housing 36. As illustrated in FIG. 1 inlet port 94 of second nipple 90 is in fluid communication with fuel 20 within chamber 16 of reservoir 14. Outlet port 56 of nipple 54 is in fluid communication with an annular conduit, such as a hose, pipe or tube, to provide flow of fuel 20 from nipple 54 and outlet port 56 through reservoir 14 and fuel tank 18 to engine 30. Rotation of turbine 120 thereby simultaneously provides a low pressure fluid flow path 220 of fuel 20 and a high pressure fluid flow path 222 of fuel 20, with each fuel path having respective inlet and outlet ports. Pump 10 pumps fuel 20 through second fluid flow path 28, which includes high pressure fluid flow path 222, from chamber 12 of reservoir 14 to engine 30.

Pump 10 pumps fuel 20 through first fluid flow path 26 to reservoir 14 at a flow rate that is greater than the flow rate that pump 10 pumps fuel 20 through second fluid flow path 28 to engine 30 to insure that chamber 12 of reservoir 14 is never low on fuel 20 and that there is always an adequate amount or volume of fuel 20 in reservoir 14 for pumping by pump 10 through second fluid flow path 28 to engine 30. As an example, pump 10 may pump fuel 20 through first fluid flow path 26 to reservoir 14 at a flow rate that is at least 105% to 110% greater than the flow rate of fuel 20 that pump 10 pumps through second fluid flow path 28 to engine 30. As a further example, pump 10 may pump fuel 20 through first fluid flow path 26 to reservoir 14 at a flow rate of approximately 55 gallons per hour, while pump 10 pumps fuel 20 through second fluid flow path 28 to engine 30 at a flow rate of approximately 50 gallons per hour.

What is claimed is:

1. A pump for pumping fluid from a fluid source to a fluid destination, the pump comprising:
a first inlet port adapted to be in fluid communication with the fluid source;
a turbine having a central axis, the turbine adapted to rotate about the central axis, the turbine being in fluid communication with the first inlet port;
a first outlet port in fluid communication with the turbine and the first inlet port, a first fluid flow path extending between the first inlet port and the first outlet port, the turbine adapted to cause fluid to flow through the first fluid flow path from the first inlet port to the first outlet port;
a second inlet port adapted to be in fluid communication with fluid discharged from the first outlet port, the turbine being in fluid communication with the second inlet port;
a second outlet port in fluid communication with the turbine and the second inlet port, a second fluid flow path extending between the second inlet port and the second outlet port, the second outlet port adapted to be placed in fluid communication with the fluid destination, the turbine adapted to cause fluid to flow through the second fluid flow path from the second inlet port to the second outlet port.

2. The pump of claim 1 wherein the turbine includes a peripheral side wall, a disk located within and spaced apart from the side wall, and a plurality of outer blades located between the disk and the side wall, the outer blades are spaced apart from one another such that a fluid passage is formed between each adjacent pair of outer blades, each fluid passage formed by the outer blades adapted to be in intermittent fluid communication with the second fluid flow path as the turbine rotates.

3. The pump of claim 2 wherein the disk of the turbine includes a plurality of inner blades that are spaced apart from one another in a generally circular manner about the central axis of the turbine.

4. The pump of claim 3 wherein the disk of the turbine includes an exterior surface and an interior surface, each inner blade comprising a bore that extends from the exterior surface of the disk to the interior surface of the disk, each bore of an inner blade adapted to in intermittent fluid communication with the first fluid flow path as the turbine rotates.

5. The pump of claim 4 wherein each bore of an inner blade is generally triangular shaped.

6. The pump of claim 3 wherein the inner blades of the turbine are located at a first distance from the central axis of the turbine and the outer blades of the turbine are located outwardly from the inner blades at a second distance from the central axis of the turbine.

7. The pump of claim 1 including an end cap, the end cap including the first inlet port, the first outlet port and the second inlet port.

8. The pump of claim 7 wherein the end cap includes an inner groove having a first end in fluid communication with the first inlet port and a second end in fluid communication with the first outlet port, the inner groove being in fluid communication with the turbine.

9. The pump of claim 8 wherein the end cap includes an outer groove having a first end in fluid communication with the second inlet port and a second end, the outer groove being in fluid communication with the turbine.

10. The pump of claim 9 wherein the turbine includes a plurality of inner blades that are adapted to be in fluid communication with the inner groove as the turbine rotates and a plurality of outer blades that are adapted to be in fluid communication with the outer groove as the turbine rotates.

11. The pump of claim 9 wherein the inner groove extends in a partial circular manner about the central axis of the turbine, and the outer groove extends in a partial circular manner about the central axis of the turbine, the outer groove being located radially outwardly from the inner groove.

12. The pump of claim 1 including a collar having an exterior surface, an interior surface, and an inner groove formed in the exterior surface of the collar having a first end and a second end, the inner groove of the collar being in fluid communication with the turbine.

13. The pump of claim 12 wherein the collar includes an outer groove formed in the exterior surface of the collar having a first end and a second end, and a bore extending through the collar from the exterior surface to the interior surface of the collar, the second end of the outer groove of the collar being in fluid communication with the bore of the collar, the bore of the collar being in fluid communication with the second outlet port.

14. The pump of claim 13 wherein the collar includes a groove formed in the interior surface of the collar having a first end in fluid communication with the bore of the collar and a second end.

15. The pump of claim 13 wherein the inner groove of the collar extends in a partial circular manner about the central axis of the turbine, and the outer groove of the collar extends in a partial circular manner about the central axis of the turbine, the outer groove of the collar being located radially outwardly from the inner groove of the collar.

16. The pump of claim 1 including a housing having a first end and a second end, the housing including the second outlet port.

17. The pump of claim 16 including a collar coupled to the first end of the housing, the collar being in fluid communication with turbine and the first fluid flow path and the second fluid flow path, and an end cap including the first inlet port, the first outlet port and the second inlet port, the end cap being in fluid communication with the turbine, the turbine being located between the collar and the end cap.

18. The pump of claim 17 including a motor coupled to the turbine, the motor adapted to selectively rotate the turbine about the central axis of the turbine.

19. The pump of claim 1 wherein the pump is located within a reservoir having a chamber adapted to contain fluid to be pumped to the fluid destination, the reservoir located within a chamber of a tank adapted to contain fluid comprising the fluid source, the first inlet port of the pump being in fluid communication with the chamber of the tank, the first outlet port of pump being in fluid communication with the chamber of the reservoir, and the second inlet port of the pump being in fluid communication with the chamber of the reservoir and the second outlet port of the pump, the turbine adapted to pump fluid from the fluid source located in the chamber of the tank into the first inlet port of the pump and out of the first outlet port of the pump into the chamber of the reservoir, and to pump fluid in the chamber of the reservoir into the second inlet port of the pump and out of the second outlet port of the pump to the fluid destination.

20. A pump for pumping fluid from a fluid source to a fluid destination, the pump comprising:
a housing having an outlet port adapted to be placed in fluid communication with the fluid destination;
a collar coupled to the housing, the collar including a bore in fluid communication with the outlet port of the housing;
a turbine having a central axis, a plurality of inner bores in fluid communication with the collar, and a plurality outer fluid passages in fluid communication with the collar, the turbine being selectively rotatable about the central axis of the turbine;
an end cap having a first inlet port in fluid communication with one or more of the inner bores of the turbine as the turbine rotates, an outlet port in fluid communication with one or more of the inner bores of the turbine as the turbine rotates, and a second inlet port in fluid communication with one or more of the outer fluid passages of the turbine as the turbine rotates.

21. The pump of claim 20 wherein the collar includes an inner groove having a first end and a second end, the inner groove of the collar being in fluid communication with one or more of the inner bores of the turbine as the turbine rotates, and an outer groove that is in fluid communication with the second outlet port and one or more of the outer fluid passages of the turbine as the turbine rotates.

22. The pump of claim 20 wherein the end cap includes an inner groove having a first end in fluid communication with the first inlet port, the first outlet port and one or more of the inner bores of the turbine as the turbine rotates, and an outer groove that is in fluid communication with the second inlet port and one or more of the outer fluid passages of the turbine as the turbine rotates.

23. A method for pumping fluid from a fluid source to a fluid destination, the method comprising:
providing a pump having a selectively rotatable turbine, a first inlet port in fluid communication with the turbine and adapted to be placed in fluid communication with the fluid source, a first outlet port in fluid communication with the turbine and the first inlet port, a second inlet port in fluid communication with the turbine, and a second outlet port in fluid communication with the turbine and the second inlet port and adapted to be placed in fluid communication with the fluid destination;
pumping fluid from the fluid source into the first inlet port of the pump and out of the first outlet port of the pump;
pumping the fluid discharged from the first outlet port of the pump into the second inlet port of the pump and out of the second outlet port of the pump.

24. The method of claim 23 wherein fluid is pumped from the first inlet port to the first outlet port through a first fluid flow path, and fluid is pumped from the second inlet port to the second outlet port through a second fluid flow path, the second fluid flow path being separate from the first fluid flow path.

25. The method of claim 24 wherein the turbine is in fluid communication with the first fluid flow path and the second fluid flow path.

26. The method of claim 23 wherein the pump pumps fluid from a chamber of a tank that comprises the fluid source into the first inlet port of the pump and out of the first inlet port of the pump into a chamber of a reservoir.

27. The method of claim 26 wherein the pump pumps fluid in the chamber of the reservoir into the second inlet port of the pump and out of the second outlet port of the pump to the fluid destination.

28. The method of claim 24 wherein the turbine pumps fluid through the second fluid flow path at a pressure that is higher than the pressure at which the turbine pumps the fluid through the first fluid flow path.

29. The method of claim 24 wherein the turbine pumps fluid through the first fluid flow path at a first flow rate and pumps fluid through the second fluid flow path at a second flow rate, the first flow rate being greater than the second flow rate.

30. The method of claim 23 wherein the fluid comprises fuel.
